(19) United States
(12) Patent Application Publication
(10) Pub. No.: US 2025/0050693 A1
(43) Pub. Date: Feb. 13, 2025

(54) SYSTEM AND METHOD FOR MOTORCYCLE MAINTENANCE

(71) Applicant: Erik Monisera, Tomball, TX (US)

(72) Inventor: Erik Monisera, Tomball, TX (US)

(21) Appl. No.: 18/233,165

(22) Filed: Aug. 11, 2023

(51) Int. Cl. B60C 25/02

(52) U.S. Cl. CPC B60C 25/02; B60C 25/0563

(57) ABSTRACT

A system and method for removing a motorcycle tire from a wheel that can include a ram, a lever, and a securing bar. The ram can be positioned on the bead of the tire. Pressure or force can be applied to the lever which in turn can apply pressure to the bead of the tire, breaking the seal between the tire and the wheel.

### FIELD OF THE DISCLOSURE

The present disclosure generally relates to motorcycle maintenance tools, and more particularly to motorcycle maintenance tools for unseating a tire from a rim of a motorcycle wheel.

### BACKGROUND

A motorcycle tire is designed to fit very firmly into a motorcycle wheel so that it may stay airtight. A challenge arises when changing a tire, as it takes a tremendous amount of force to “unseat” the tie bead from the rim, all while applying the force very precisely to push on the tire and not damage the rim and/or wheel. Maintenance shops have heavy, complex machines for this task, but very few cheap, effective products exist for the home mechanic who wants to do this themselves.

### SUMMARY

Embodiments of the present disclosure may provide a method for performing motorcycle maintenance using a maintenance tool, wherein the method may comprise inserting a lever into the maintenance tool, the lever having a first side and a second side, securing the first side of the lever against a solid surface, positioning the maintenance tool on a motorcycle wheel, wherein pressure point of the maintenance tool can be positioned on a seam between the motorcycle wheel and a tire, and applying pressure to the second side of the lever. Before inserting the lever, the method may include adjusting a first side of a fork and a second side of a fork to a width of a lever. The solid surface may be a wall, fence, car, or auxiliary frame. The method also may include before positioning the maintenance tool, placing the motorcycle wheel on a flat surface. The flat surface may be the ground, a mount, a frame, or combinations thereof.

Other embodiments of the present disclosure may provide a system for removing a tire from a motorcycle wheel, wherein the system may comprise a ram, a lever, and a securing bar. The ram can comprise a pressure point, an arm, a fork, and a lever opening, wherein the lever opening may be formed by the fork. The pressure point may have a backstop and/or may have a U shape. The arm may be hollow. The fork may include a base; a first side; and a second side, wherein the first side and the second side may be connected to opposite ends of the base. The first side and the second side may be slidable along the base. The system also may include one or more channels, wherein the one or more channels may be connectable to the first side and the second side. The securing bar may be connected to the system with one or more securing devices. The one or more securing devices may be nails, screws, bolts, or combinations thereof. The ram may have a height of less than 12 inches or may have a height between 12 inches and 18 inches.

### BRIEF DESCRIPTION OF THE DRAWINGS

For a more complete understanding of this disclosure, reference is now made to the following description, taken in conjunction with the accompanying drawings, in which:

FIG. 1 depicts a perspective view of a motorcycle maintenance system according to an embodiment of the present disclosure;

FIGS. 2A-2C depict perspective views of a motorcycle maintenance tool according to an embodiment of the present disclosure;

FIG. 3 depicts a perspective view of a motorcycle maintenance tool according to an embodiment of the present disclosure; and

FIG. 4 depicts a perspective view of a motorcycle maintenance system according to an embodiment of the present disclosure.

### DETAILED DESCRIPTION

Embodiments of the present disclosure may provide a method and system for motorcycle maintenance, and more specifically changing tires for motorcycles. The present disclosure may provide a portable system that can be disassembled and transported anywhere where maintenance can be performed safely and with enough control as to not damage the wheel or tire.

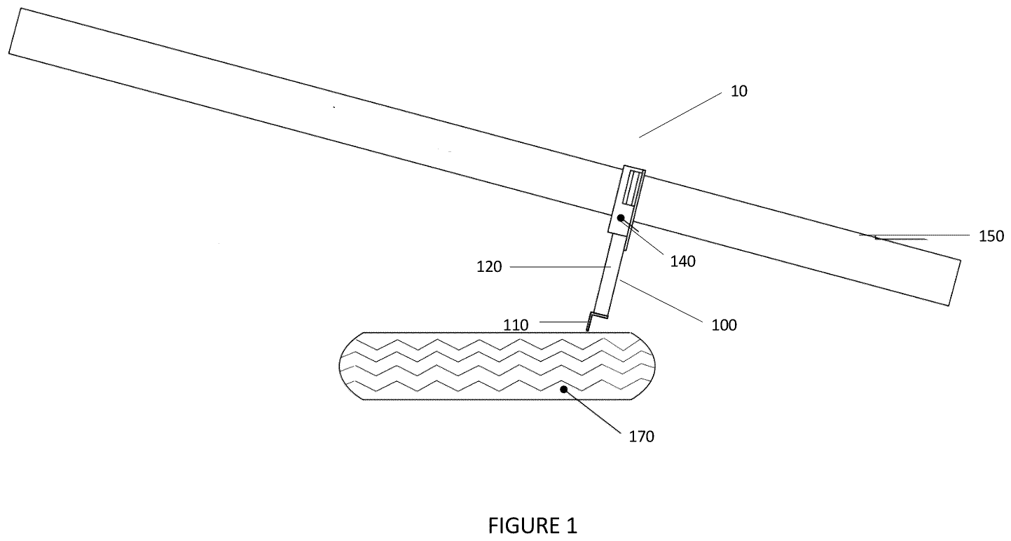

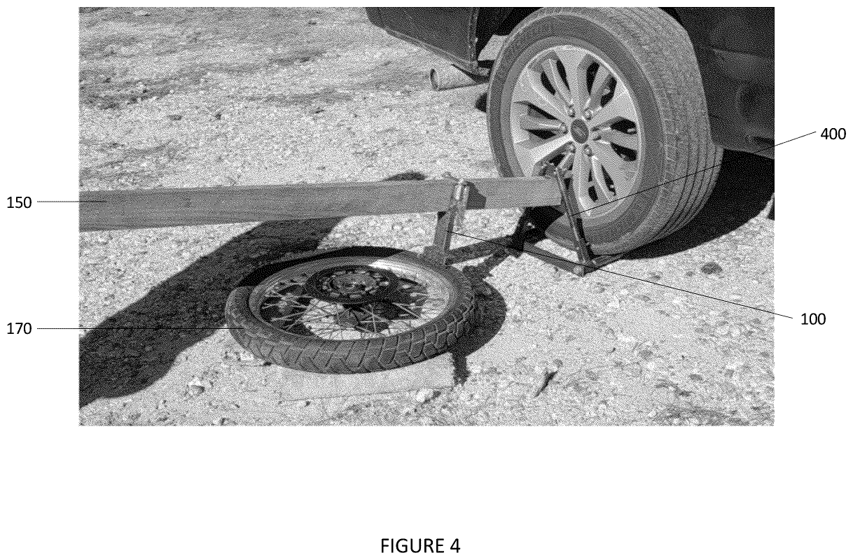

FIG. 1 depicts a perspective view of motorcycle maintenance system 10. Maintenance system 10 can include ram 100 and lever 150. Ram 100 can be affixed to a common 2×4, which can create a second-class lever whose fulcrum can be under a vehicle's sturdy bumper or a permanent structure to press the tire bead off a flat-lying rim. Other materials can be used for lever 150 without departing from embodiments of the present disclosure. Different materials and materials of different lengths can be used based on the materials available to the user and tire 170 being removed. If no sturdy structure is available to the user, ancillary frame 400 (FIG. 4) can accompany ram 100, and frame 400 may be secured to the ground by parking a vehicle's tire over it, creating a non-moving fulcrum.

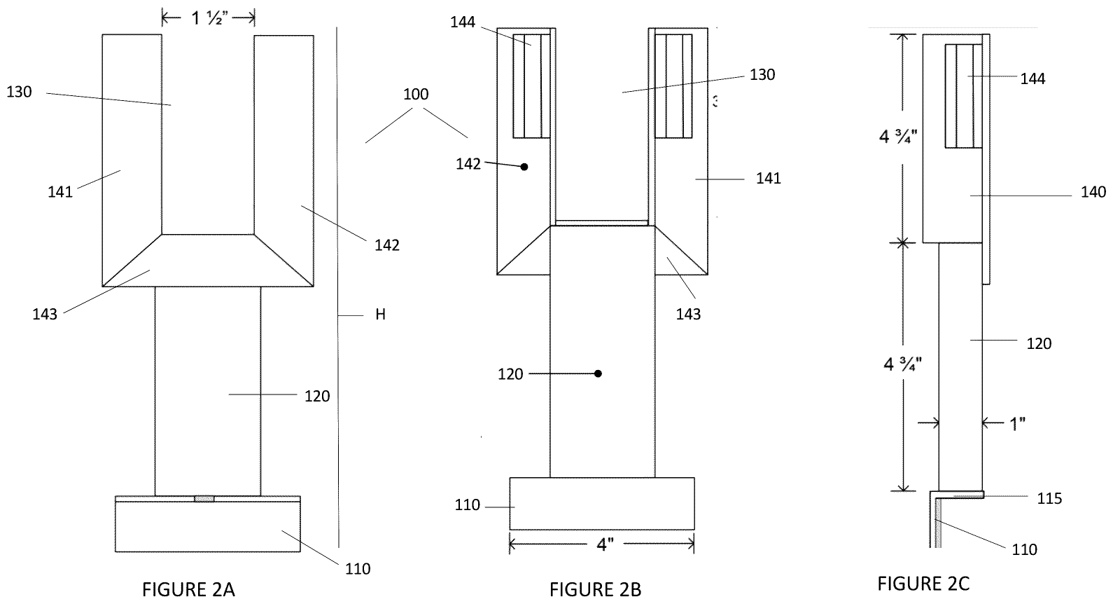

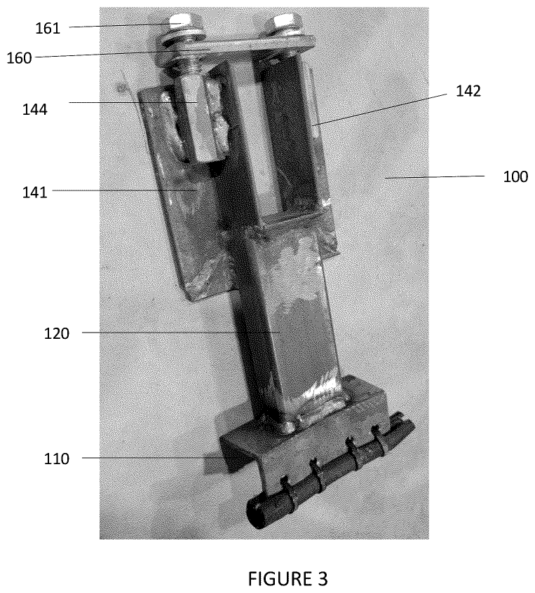

Ram 100 can include pressure point 110, arm 120, fork 140, lever opening 130 (FIGS. 2A-2B), and securing bar 160 (FIG. 3). Pressure point 110 can be a thin piece of material that may taper towards an end. Pressure point 110 can be configured to rest near a bead of tire 170. The bead of tire 170 can be a reinforced section of tire 170 that comes into contact with a rim of a wheel. The bead of tire 170 can create and maintain the seal between tire 170 and the wheel. Pressure point 110 can come into contact with an area where the bead of tire 170 meets the wheel. When pressure or force is applied to maintenance system 10, pressure point 110 can apply pressure to the area where the bead of tire 170 meets the wheel and break the seal formed. The pressure applied through pressure point 110 can be enough to break the seal, taking tire 170 off the wheel without damaging the wheel. Pressure point 110 can have backstop 115. Backstop 115 can be connected to arm 120. Backstop 115 can be perpendicular to pressure point 110 and can be configured to stop the forward momentum of pressure point 110 when backstop 115 (FIG. 2C) comes into contact with tire 170. Backstop 115 coming into contact with tire 170 can prevent pressure point 110 from traveling further and damaging the wheel.

Arm 120 can be connected to backstop 115 and fork 140. Arm 120 can be configured to create distance between pressure point 110 and lever 150. Arm 120 can be made of a sturdy material so that pressure or force may be applied to lever 150. Arm 120 can be made of a solid piece of material or can be a hollow tube to reduce the weight of ram 100.

Fork 140 can be connected to arm 120 and can form lever opening 130. Fork 140 can be shaped like a U or other similar shape. Fork 140 as depicted, for example, in FIGS. 2A-2B, can have first side 141, second side 142, and base 143. Base 143 can be connected perpendicularly to arm 120. First side 141 and second side 142 can each be connected perpendicularly to opposite sides of base 143 to create the U shape. The U shape formed by fork 140 can create lever opening 130. Lever opening 130 can be configured to accept different materials to act as a second-class lever for maintenance system 10. Lever opening 130 depicted in FIG. 2A can be sized to accept a wooden 2×4 to act as lever 150; however, other similar materials may be used for lever 150 without departing from the present disclosure. Lever opening 130 can be made different sizes to accept materials that may be available for different users.

Other embodiments of fork 140 can have channels in base 143 that can allow first side 141 and second side 142 to move along base 143 to adjust the size of lever opening 130 based on the material to be used as lever 150. Adjustable fork 140 can provide the benefit of adjusting to whatever size is needed to accommodate the materials available for the user.

Lever 150 can be a sturdy material that may not warp or break when pressure or force is applied. Lever 150 can be secured in lever opening 130 of fork 140 with securing bar 160. Securing bar 160 can be connected to one or more channels 144 in fork 140 using a securing mechanism selected from the group that may include but is not limited to bolts, screws, nails, other securing means, or combinations thereof. One end of lever 150 can be placed under a large or secured object. The object can be a wall, fence, car, or other generally large object that will not move in response to the pressure or force applied. Second side 152 of lever 150 can be used for the user to apply force or pressure to maintenance system 10.

FIGS. 2A-2C depict perspective views of a motorcycle maintenance tool, or ram 100. Ram 100 can include pressure point 100, arm 120, fork 140, and lever opening 130. FIG. 2A can show a back perspective view of ram 100. The back view of ram 100 depicts a solid form of ram 100. Despite being made of solid metal, with certain embodiments being hollow, ram 100 can be relatively lightweight making for easy use and transportation. Ram 100 can have a total height H. The height H can be approximately between 8 inches and 18 inches. Alternatively, the height H can be between 9 inches and 12 inches. Some embodiments of ram 100 may include pressure point 110 that may be curved to correspond to the curve of tire 170 and the wheel. Other embodiments of ram 100 can have pressure point 110 that can be two pieces at an obtuse angle to correspond to the curve of tire 170 and the wheel.

As depicted in FIGS. 2A and 2B, a fork can be different on a front side of ram 100 (FIG. 2B) and a back side of ram 100 (FIG. 2A). The back side of fork 140 can be a flat surface of material in an embodiment of the present disclosure. The front side of fork 140 can have an L shape. The L shape can be formed of a single piece of material or can be two pieces of material connected to one another in embodiments of the present disclosure. The L shape can form body portion 145 that makes up the back side of fork 140 and inside portion 146 that forms lever opening 130. Lever opening 130 may be formed by the larger flat surface of inside portion 146 to provide more surface area for lever 150 to rest on and transfer pressure or force.

Base 143 of fork 140 can be wider than arm 120. Base 143 can be wider than arm 120 to accommodate first side 141 and second side 142 and allow lever opening 130 to be the same or substantially similar width to arm 120. Other embodiments of ram 100 can have base 143 and lever opening 130 that may be wider or narrower than the width of arm 120 without departing from the present disclosure.

First side 141 and second side 142 can each have one or more channels 144 configured to accept securing device 161. Securing device 161 can be selected from the group including, but not necessarily limited to, nails, screws, bolts, other securing means, or combinations thereof. One or more channels 144 can correspond to securing device 161 used. One or more channels 144 can be connected to body portion 145 of first side 141 and second side 142. In certain embodiments of ram 100, body portion 145 can be a hollow tube, rather than L-shaped. In these embodiments, one or more channels 144 can be housed inside of the hollow tube of body portion 145.

FIG. 3 depicts a perspective view of a motorcycle maintenance tool, or ram 100. FIG. 3 depicts ram 100 with securing bar 160 attached. FIG. 3 also depicts an embodiment of pressure point 110 with a U shape rather than an L shape. The U shape depicted in FIG. 3 can provide additional support to prevent ram 100 from traveling too far and damaging the wheel. The U shape depicted in FIG. 3 also may have padding attached to the end to prevent the metal from damaging the wheel or tire 170. The U shape of pressure point 110 can also aid in the function of ram 100. Pressure point 110 can be placed where the bead of tire 170 meets the wheel and then pressure or force may be applied to ram 100. Instead of traveling straight down in response to the pressure or force, pressure point 110 can travel in an arc due to the U shape. The arc can help pressure point 110 break the seal between tire 170 and the wheel.

Arm 120 can be hollow to reduce the weight of ram 100. Fork 140 can then be attached to arm 120. Fork 140 depicted in FIG. 3 may include base 143 connected to a side and an end of arm 120. Body portion 145 of the fork can be parallel to arm 120. Inside portion 146 of fork 140 can be perpendicular to arm 120. One or more channels 144 may be connected to both body portion 145 and inside portion 146 to create a strong bond between one or more channels 144 and ram 100. Securing bar 160 may then be connected to ram 100 using securing device 161. Securing device 161 depicted in FIG. 3 may be screws to hold the securing bar to ram 100 holding lever 150 in place while ram 100 is used. However, other securing mechanisms may be used without departing from the present disclosure.

FIG. 4 depicts a perspective view of motorcycle maintenance system 10. Ram 100 can have lever 150 placed through lever opening 130 and then secured using securing bar 160. Pressure point 110 of ram 100 can be placed at the area where the bead of tire 170 meets the wheel. Auxiliary frame 400 can be placed nearby with one end of the lever being placed in frame 400. The user can apply pressure or force to the end of lever 150 that is not in frame 400. As the user applies pressure, the end of lever 150 in frame 400 may be inclined to lift, but frame 400 keeps lever 150 in place. This may place pressure down through ram 100. This pressure may then be applied at the precise point of pressure point 110 of ram 100 to the seal created between tire 170 and the wheel. The pressure can then break the seal removing tire 170 from the wheel.

The present disclosure may also provide a method of using motorcycle maintenance system 10 to remove motorcycle tire 170 from a wheel. The method can include inserting lever 150 into a maintenance tool, or ram 100, securing first side 151 of lever 150 against a solid surface, positioning the maintenance tool, or ram 100, on a motorcycle wheel, wherein pressure point 110 of ram 100 may be positioned on a seam between the motorcycle wheel and tire 170, and applying pressure to second side 152 of lever 150.

The first step of the method can be inserting lever 150 into ram 100. Ram 100 can be a relatively small and portable tool for individual users. Ram 100 may not include lever 150, but numerous materials can be inserted into lever opening 130 of ram 100 and secured into lever opening 130 with securing bar 160. Lever 150 can be a 2×4 as depicted in FIG. 4, or another long sturdy material without departing from embodiments of the present disclosure.

The second step of the method can be securing first side 151 of lever 150 against a solid surface. First side 151 of lever 150 can be secured under or against a solid surface so that it does not move when pressure or force is applied to the other end of lever 150. This may create a second-class lever that may then transfer the pressure or force down through ram 100. The solid surface can be a wall, fence, car, or other heavy, solid surface. In certain cases, a usable surface will not be available to the user. In such embodiments, auxiliary frame 400, or other device, can be used to provide a usable surface to secure first end 151 of lever 150.

The third step of the method can be positioning ram 100 on a wheel. Maintenance system 10 can be used to separate tire 170 from a wheel. Ram 100 can be positioned with pressure point 110 placed on the area where tire 170 meets the wheel. This will allow ram 100 to apply pressure to this area and break the seal between tire 170 and the wheel, allowing tire 170 to be removed. Pressure point 110 can be placed on the bead of tire 170. The bead is the portion of tire 170 that creates the seal. Tire 170 can be placed flat on the ground, or in a frame to allow ram 100 to be properly positioned on the bead of tire 170. Some users may desire to place the wheel in a frame so that the pressure or force being applied does not bend or warp the wheel.

The fourth step of the method can be applying pressure to second side 152 of lever 150. Second side 152 of lever 150 can extend over the wheel. When pressure or force is applied to second side 152 of lever 150, that pressure or force can travel along the lever to first side 151 of lever 150. Since first side 151 of lever 150 is secured against a surface, the pressure is not able to move first side 151 at all. Since first side 151 cannot move, the pressure may then transfer into ram 100. Pressure point 110 may apply this pressure to the precise point of the bead of tire 170. The bead of tire 170, and the seal created by the bead, may not be as strong as the surface against first side 151 may be secured. Accordingly, the seal will break, removing tire 170 from the wheel.

Although the present disclosure and its advantages have been described in detail, it should be understood that various changes, substitutions, and alterations can be made herein without departing from the spirit and scope of the disclosure as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A method for performing motorcycle maintenance using a maintenance tool, the method comprising:
inserting a lever into the maintenance tool, the lever having a first side and a second side;
securing the first side of the lever against a solid surface;
positioning the maintenance tool on a motorcycle wheel, wherein a pressure point of the maintenance tool is positioned on a seam between the motorcycle wheel and a tire; and
applying pressure to the second side of the lever.

2. The method of claim 1 further comprising:
before inserting the lever, adjusting a first side of a fork and a second side of a fork to a width of a lever.

3. The method of claim 1, wherein the solid surface is a wall, fence, car, or auxiliary frame.

4. The method of claim 1 further comprising:
before positioning the maintenance tool, placing the motorcycle wheel on a flat surface.

5. The method of claim 4, wherein the flat surface is the ground, a mount, a frame, or combinations thereof.

6. A system for removing a tire from a motorcycle wheel, comprising:
a ram, comprising:
a pressure point;
an arm;
a fork;
a lever opening, wherein the lever opening is formed by the fork;
a lever; and
a securing bar.

7. The system of claim 6, wherein the pressure point has a backstop.

8. The system of claim 6, wherein the pressure point has a U shape.

9. The system of claim 6, wherein the arm is hollow.

10. The system of claim 6, the fork comprising:
a base;
a first side; and
a second side, wherein the first side and the second side are connected to opposite ends of the base.

11. The system of claim 10, wherein the first side and the second side are slidable along the base.

12. The system of claim 10, the fork further comprising:
one or more channels, wherein the one or more channels are connectable to the first side and the second side.

13. The system of claim 6, wherein the securing bar is connected to the system with one or more securing devices.

14. The system of claim 13, wherein the one or more securing devices are nails, screws, bolts, or combinations thereof.

15. The system of claim 6, wherein the ram has a height of less than 12 inches.

16. The system of claim 6, wherein the ram has a height between 12 inches and 18 inches.
